(19) United States
(12) Patent Application Publication
(10) Pub. No.: US 2022/0055509 A1
(43) Pub. Date: Feb. 24, 2022

(54) Method for Producing a Covering Material for a Covering, Covering Material for a Covering, and Vehicle Seat

(71) Applicant: ADIENT ENGINEERING AND IP GMBH, BURSCHEID (DE)

(72) Inventors: Daniel Bahr, Kuerten (DE); Thomas Frotz, Wermelskirchen (DE); Lars Hennig, Leichlingen (DE); Uwe Schulze, Koeln (DE)

(73) Assignee: ADIENT ENGINEERING AND IP GMBH, BURSCHEID (DE)

(21) Appl. No.: 17/275,721

(22) PCT Filed: Sep. 27, 2019
(86) PCT No.: PCT/EP2019/076162

§ 371 Date: Mar. 12, 2021

(30) Foreign Application Priority Data
Oct. 4, 2018 (DE) 10 2018 124 540.8

(51) Int. Cl. B60N 2/58

(52) U.S. Cl. CPC B60N 2/5891; B60N 2/5816

(57) ABSTRACT

A method for producing a covering material for a covering for a vehicle seat may include the steps of providing at least one flat starting material, making positioning openings in the starting material, and laying at least one ply of the at least one starting material into a tool frame having a plurality of positioning pins. The positioning pins of the tool frame may be guided through the positioning openings in the starting material. The steps may also include applying a material processing method to the at least one laid-in ply and removing the at least one processed ply from the tool frame. A covering material for a covering for a vehicle seat and to a vehicle seat are also disclosed.

The invention relates to a method for producing a lining material for a lining, in particular for a vehicle seat, to a corresponding lining material for a lining, and also to a vehicle seat.

### PRIOR ART

Methods for producing a seat lining, and seat linings, are generally known from the prior art. U.S. Pat. No. 3,841,700 describes a kit for producing seat linings for front seats and rear seats or for a backrest and a seat part. Here, semi-finished products are pre-sewn which have webs made of different materials for seat surface, side surface, cover surface and rear side. Said pre-sewn semi-finished products are trimmed and finally sewn in accordance with the specific seat dimensions by means of a predefined cutting sequence.

In a unit of a raw-materials supplier, after laminating, usually a flame laminating process, materials which are intended for a seat lining are wound onto reels, packaged and subsequently dispatched to a trimming unit. At the trimming unit, said materials are cut into the required parts by way of a cutter and are fed to a sewing process.

### Problem

The invention is based on the problem of improving a method for producing a lining material for a lining, in particular for a vehicle seat, of the type mentioned in the introduction, in particular of providing a highly precise method for producing a lining, and also a corresponding vehicle seat.

### Solution

Said problem is solved according to the invention by a method for producing a lining material for a lining, in particular for a vehicle seat, the method comprising the following method steps of:
a) providing at least one flat starting material,
b) introducing positioning openings into the starting material,
c) inserting at least one layer of the at least one starting material into a tool frame having a plurality of positioning pins, wherein the positioning pins of the tool frame are guided through the positioning openings in the starting material,
d) implementing a material machining process on the at least one inserted layer,
e) removing the at least one machined layer from the tool frame.

Advantageous configurations, which can be employed individually or in combination with one another, are provided by the subclaims.

Subsequent to method step e), the following method steps can be provided:
f) inserting the at least one machined layer into a further tool frame,
g) implementing a further material machining process on the at least one layer which is inserted into the further tool frame,
h) removing the at least one previously machined layer from the further tool frame.

Between the method steps d) and e) or g) and h), implementation of a further material machining process can be carried out on the at least one layer which is inserted into the frame or into the further tool frame.

The implementation of the material machining process can be limited to predefined regions of the at least one layer. The implementation of the material machining process can be carried out at predefined positions on the at least one layer.

Prior to or subsequent to method step f), at least one further layer which is provided with positioning openings and which is made of at least one starting material can be inserted into the further tool frame.

At least two layers made of at least one starting material can be inserted in method step c). As an alternative, at least two layers made of at least two different starting materials can be inserted in method step c).

The at least two layers can be oriented relative to one another and relative to the tool frame by means of the positioning pins and the positioning openings.

The starting material can be formed from at least one of the following materials: a nonwoven, a knitted fabric, a woven fabric, a leather, a synthetic leather.

The material machining process can comprise at least one of the following measures: sewing, thermal welding, ultrasonic welding, punching, embossing, pressing, grinding, brushing, impregnating, perforating, shagreening, cutting, carving, printing.

The underlying problem is also solved according to the invention by a lining material for a lining, in particular for a vehicle seat, produced by a method according to the preceding description.

The underlying problem is further solved according to the invention by a vehicle seat having a lining comprising a lining material according to the preceding description.

### FIGURES AND EMBODIMENTS OF THE INVENTION

The invention is explained in more detail below on the basis of advantageous exemplary embodiments which are illustrated in the figures. The invention is however not restricted to these exemplary embodiments. In the drawings:

FIG. 1: shows a perspective view of a front side of a vehicle seat with a lining, comprising a lining material, produced by a method according to the invention,

FIG. 2: shows a perspective view of a rear side of the vehicle seat of FIG. 1,

FIG. 3: shows a sketched illustration of a base element of a tool frame,

FIG. 4: shows a schematic sectional illustration through a plurality of layers of a starting material,

FIG. 5: shows a sketched illustration of the tool frame together with a tool part arranged therebelow,

FIG. 6: shows an enlarged illustration of a detail of the tool part of FIG. 5,

FIG. 7: shows an illustration of a lining material for a backrest according to a first exemplary embodiment,

FIG. 8: shows an illustration of a lining material for a seat part according to the first exemplary embodiment,

FIG. 9: shows an illustration of a lining material for a backrest according to a second exemplary embodiment,

FIG. 10: shows an illustration of a lining material for a seat part according to the second exemplary embodiment,

FIG. 11: shows a sketched illustration of a lower side of a base element and of a retaining element of a further tool frame,

FIG. 12: shows an enlarged illustration of a detail of the retaining element of FIG. 11,

FIG. 13: shows a sketched, partially transparent illustration of the retaining element of the further tool frame, and

FIG. 14: shows a sketched illustration of an upper side of a retaining element of the further tool frame.

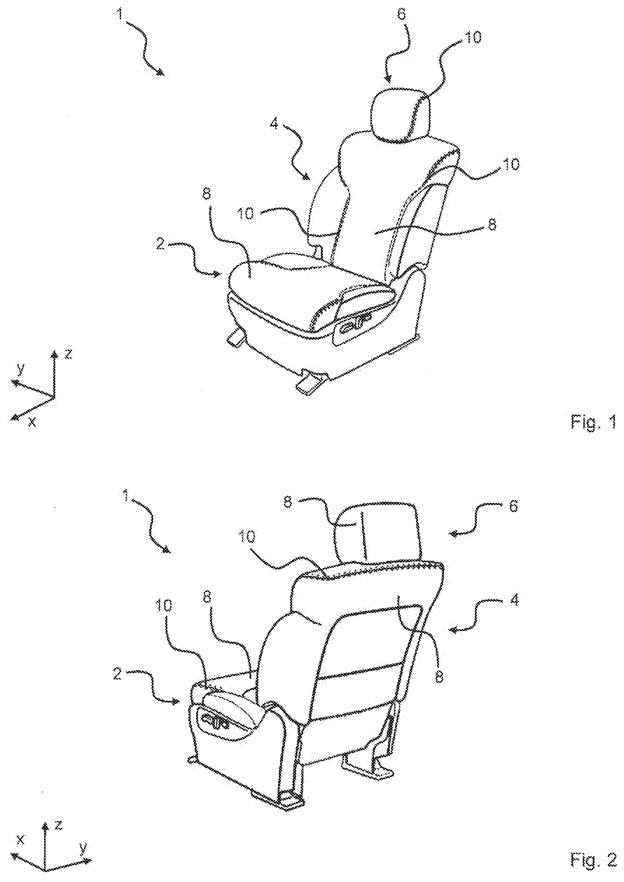

FIGS. 1 and 2 show a perspective view of a front side and a rear side, respectively, of a vehicle seat 1. The vehicle seat 1 is described below using three spatial directions which extend perpendicularly with respect to one another. In the case of a vehicle seat 1 installed in the vehicle, a longitudinal direction x extends largely horizontally and preferably parallel to a vehicle longitudinal direction, which corresponds to the normal direction of travel of the vehicle. A transverse direction y, which extends perpendicularly with respect to the longitudinal direction x, is likewise oriented horizontally in the vehicle, and extends parallel to a vehicle transverse direction. A vertical direction z extends perpendicularly with respect to the longitudinal direction x and perpendicularly with respect to the transverse direction y. In the case of a vehicle seat 1 installed in the vehicle, the vertical direction z extends parallel to the vehicle vertical axis.

The positional and directional indications used, such as for example front, rear, top and bottom, relate to a viewing direction of an occupant seated in the vehicle seat 1 in a normal seating position, wherein the vehicle seat 1 is installed in the vehicle, in a use position suitable for passenger transport, with an upright backrest 4, and is oriented in the conventional manner in the direction of travel. The vehicle seat 1 according to the invention may however also be installed in a different orientation, for example transversely with respect to the direction of travel.

The vehicle seat 1 for a motor vehicle has a seat part 2 and a backrest 4 whose inclination can be adjusted relative to the seat part 2. A headrest 6 is retained at an upper end of the backrest 4. Both the seat part 2, the backrest 4 and the headrest 6 can be covered by means of a respective lining 8. The lining 8 is adapted in each case to the corresponding shape of the covered body, in particular the seat part 2 or the backrest 4 or the headrest 6. For this purpose, various blanks made of a lining material according to the invention are sewn together in the region of a seam 10 shown and are applied on a cushion, which is not designated in any more detail, of the body to be covered, in particular of the seat part 2 or of the backrest 4 or of the headrest 6.

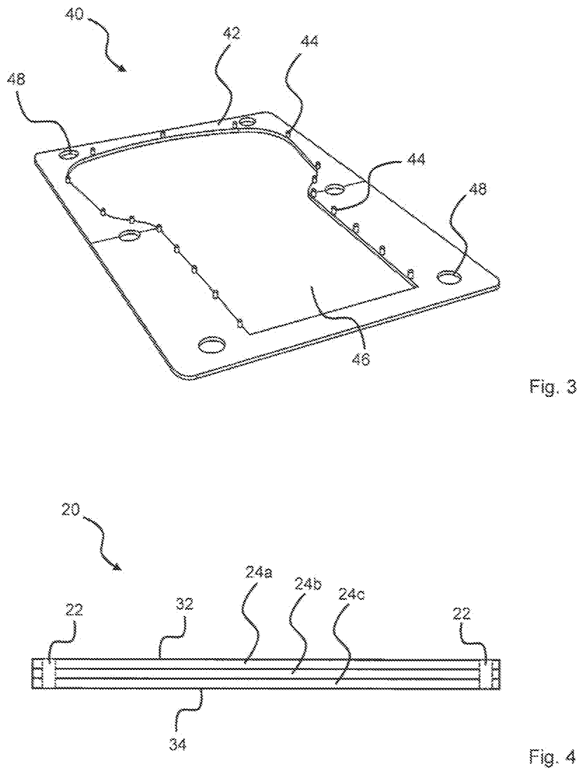

FIG. 3 shows a base element 42 of a tool frame 40, which can be used in a method according to the invention for producing a lining material for a lining 8, in particular for the vehicle seat 1. The tool frame 40 has a base element 42. The base element 42 has a central opening 46. Positioning pins 44 are arranged around the edge region of the opening 46. In addition, the base element 42 has retaining openings 48 in order to retain or to guide the base element 42 of the tool frame 40 in a tool part 70 which interacts therewith. The base element 42 is used to orient and to retain a starting material 20 which is to be machined by means of a material machining process. When the base element 42 of the tool frame 40 is retained in the tool part 70, access to the insertable starting material 20 is provided by the opening 46.

FIG. 4 shows a sectional illustration through a plurality of layers of the starting material 20. In the present case, the starting material 20 is formed from a first layer 24a, a second layer 24b and a third layer 24c. In a deviation therefrom, the starting material 20 may however also be composed of fewer or more layers of different materials.

The starting material 20 is provided with positioning openings 22 which have an arrangement that corresponds to the positioning pins 44 of the tool frame 40. Consequently, the first layer 24a, the second layer 24b and the third layer 24c can be successively clamped into the base element 42 of the tool frame 40. The first layer 24a, which is arranged at the top in the present case, provides a surface 32 which, in the finished lining 8, can be an outwardly directed, visible surface 32. The third layer 24a, which is arranged at the bottom in the present case, provides a further surface 34 which faces away from the surface 32. In the finished lining 8, the further surface 34 can be a non-visible surface 34 which is oriented toward the cushion body. The first layer 24a can be composed of leather, for example. The second layer 24b can be a nonwoven, for example. The third layer 24c can be a foam, for example.

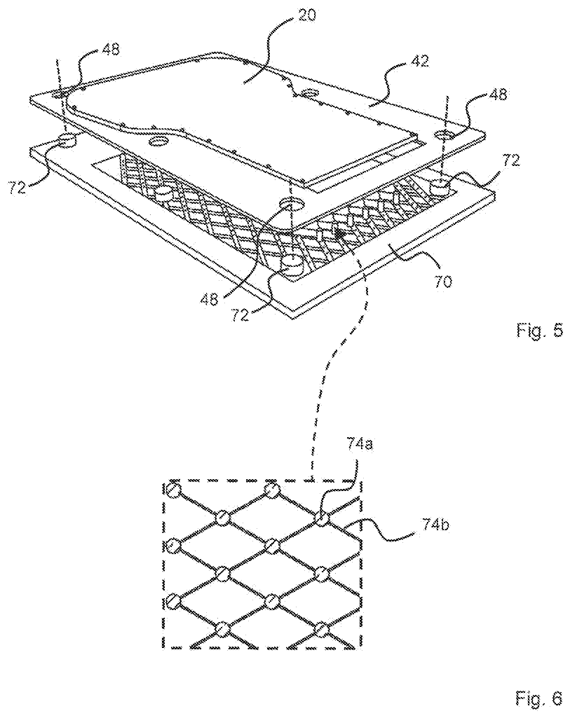

FIG. 5 shows the tool frame 40 together with the tool part 70 which is arranged below the tool frame 40. FIG. 6 shows a detail of the tool part 70. The tool part 70 has guide elements 72 which cooperate with the openings 48 of the tool frame 40 in such a way that the tool frame 40 can be fed to the tool part 70 in a uniform movement along the guide elements 72. The starting material 20 which is fixed to the base element 42 of the tool frame 40 can thus be fed to the tool part 70. The tool frame 40 and the tool part 70 are each a constituent part of a more comprehensive tool which is not shown completely for reasons of illustration.

In the present case, the tool part 70 shown is a welding tool. The enlarged detail in FIG. 6 shows a plurality of welding elements 74a, 74b in detail. In the present case, the welding elements 74a, 74b form, in the starting material 20, a rhomboidal pattern of welding points 36a and welding lines 36b, in particular with welding points 36a which are arranged with an offset and welding lines 36b which connect said welding points 36a to one another. The welding elements 74a generate the welding points 36a, and the welding elements 74b generate the welding lines 36b. By way of example, thermal welding or ultrasonic welding can be carried out with the welding tool. Thermal welding or ultrasonic welding can for example represent an implementation of a material machining process.

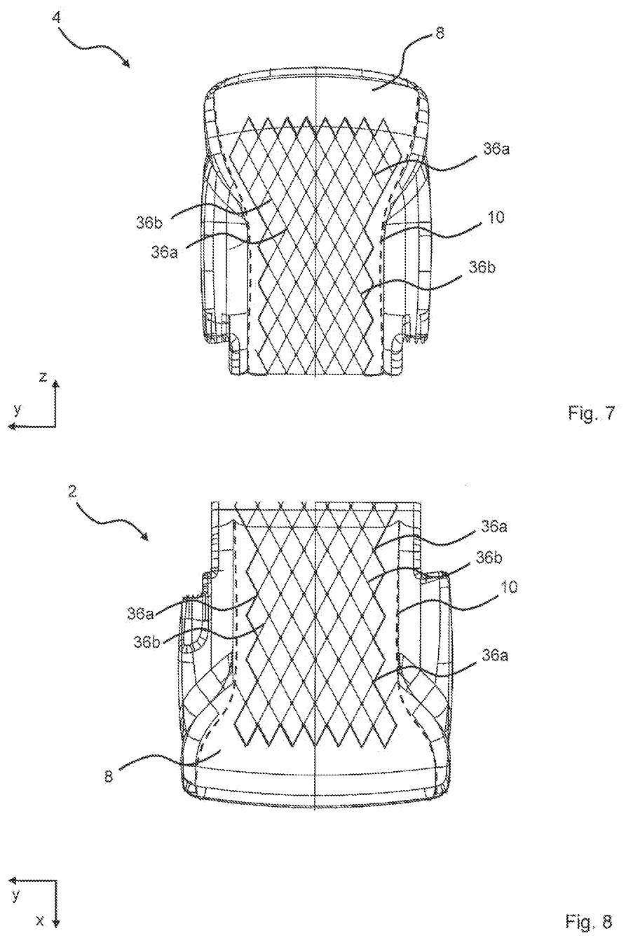

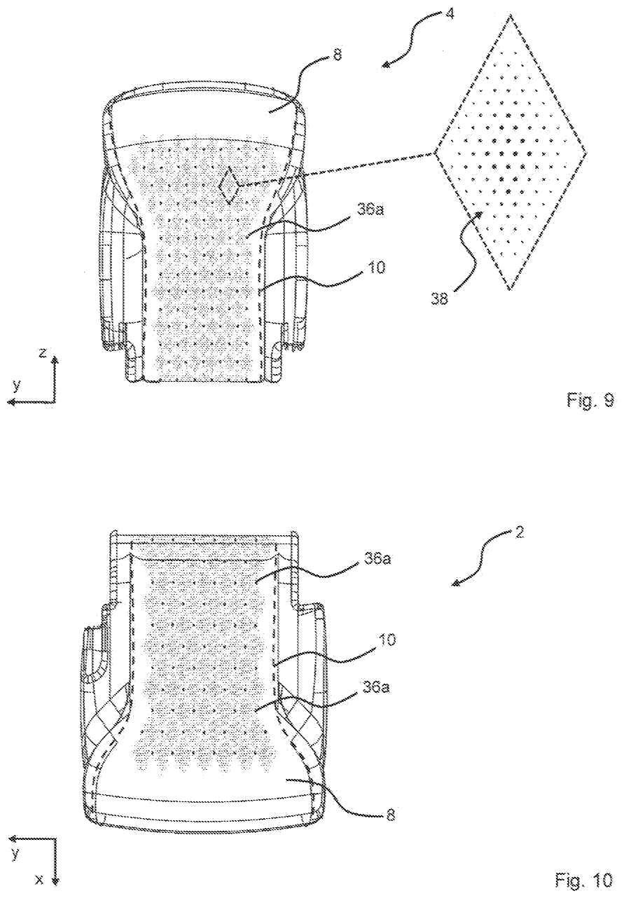

The first layer 24a, the second layer 24b and the third layer 24c are welded to one another in a predefined pattern. This makes it possible to form a three-dimensional pattern on the lining 8 according to a first exemplary embodiment, as is schematically shown in FIGS. 7 and 8. The linings 8 of the backrest 4 and of the seat part 2 have a rhomboidal pattern which is formed by, at the respective corners of the individual rhombuses, by means of welding points 36a and welding lines 36b which connect the welding points 36a.

FIGS. 9 and 10 show a lining 8 for the backrest 4 and the seat part 2, respectively, according to a second exemplary embodiment. The lining 8 according to the second exemplary embodiment has merely the welding points 36a of the rhomboidal pattern, without the connecting welding lines 36b. However, inside each imaginary rhomboidal portion, as shown in the enlarged detail, the pattern of the lining 8 according to the second exemplary embodiment has a hole pattern 38 which is formed in particular by means of a punching process as material machining process. Here, the respective diameters of the holes reduce from a center of the portion toward an edge of the portion. A base element 42 of the second exemplary embodiment corresponds to the base element 42 described above.

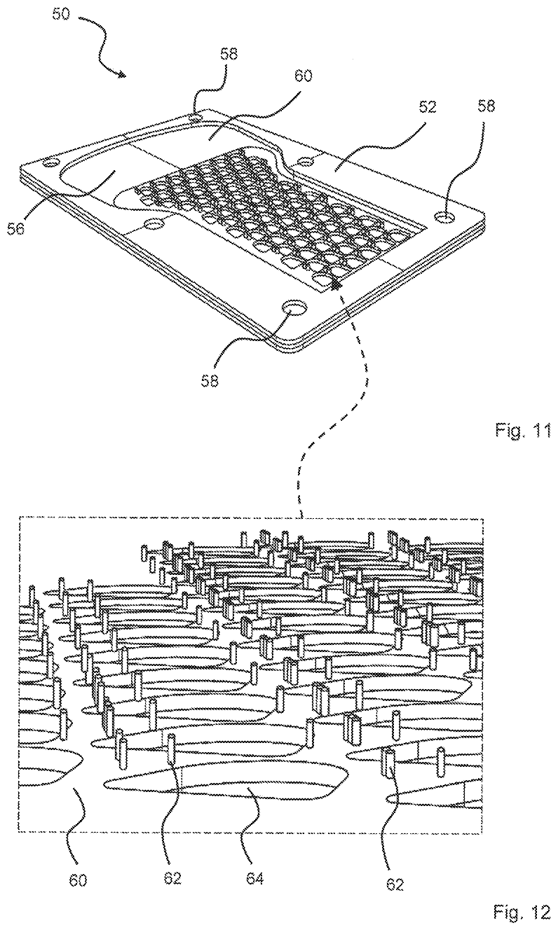

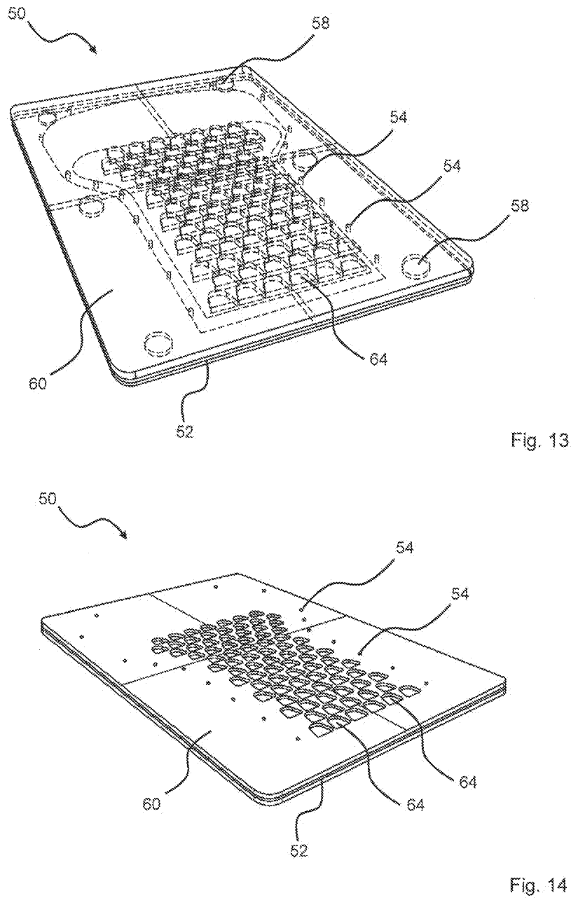

FIG. 11 shows a lower side of a base element 52 of a further tool frame 50 with a retaining element 60. FIG. 12 shows an enlarged illustration of a detail of the retaining element 60 of FIG. 11. FIG. 13 shows the retaining element 60, illustrated in partially transparent fashion, on the base element 52 of the further tool frame 50, and FIG. 14 shows an upper side of the retaining element 60. The further tool frame 50 is likewise a constituent part of a more comprehensive tool which is not shown completely for reasons of illustration.

The base element 52 has a central opening 56. The opening 56 of the base element 52 can deviate in terms of shape and size from the opening 46 of the base element 42 of the first exemplary embodiment but must lie within arranged positioning pins 54. The arrangement and the position of the positioning pins 54 of the base element 52 of the further tool frame 50 are identical to those of the base element 42 of the tool frame 40 of the first exemplary embodiment. In addition, the base element 52 has retaining openings 58 in order to retain or to guide the base element 52 in a tool part 70. The number and shape of the retaining openings 58 of the further tool frame 50, or else of the retaining openings 48 of the frame 40, are generally adapted to the respective tool part 70. In all of the tool frames 40, 50, merely the number, size and position of the respective positioning pins 44, 54 are identical, such that the starting material 20 can be transferred, both in a non-machined state and in a partially machined state, from a first tool part 70 to the second tool part 70, that is to say from a tool frame 40 to the further tool frame 50, without said material needing to be reoriented relative to the second tool part 70.

The retaining element 60 has, on a side facing the base element 52, a multiplicity of protruding retaining pins 62. Openings 64 are arranged between the retaining pins 62. The retaining pins 62 are preferably oriented flush with the holes with greatest diameter of the hole pattern 38. The openings 64 are correspondingly positioned above the welding points 36a, such that a corresponding tool part 70 has access to the welding points 36a in order to carry out a further material machining step there. By way of example, introduction of a sewing thread or adhesive bonding of a cover element, such as for example a button.

The features which are disclosed in the description above, in the claims, and in the drawings may be of importance, both individually and in combination, for the implementation of the invention in its various configurations.

Even though the invention has been described in detail in the drawings and in the above illustration, the illustrations are to be understood as being illustrative and exemplary and non-restrictive. In particular, the selection of the proportions of the individual elements illustrated in the drawing is not to be interpreted as being necessary or restrictive. Furthermore, the invention is in particular not restricted to the exemplary embodiments discussed. Further variants of the invention and the embodiment thereof emerge to a person skilled in the art from the preceding disclosure, from the figures and from the claims.

Terms such as “comprise”, “have”, “include”, “contain” and the like used in the claims do not rule out further elements or steps. The use of the indefinite article does not rule out a plurality. A single device may perform the functions of several of the units or devices mentioned in the claims.

### LIST OF REFERENCE DESIGNATIONS

1 Vehicle seat
2 Seat part
4 Backrest
6 Headrest
8 Lining
10 Seam
20 Starting material
22 Positioning opening
24a First layer
24b Second layer
24c Third layer
32 Surface
34 Surface
36a Welding point
36b Welding line
38 Hole pattern
40 Tool frame
42 Base element
44 Positioning pin
46 Opening
48 Retaining opening
50 Further tool frame
52 Base element
54 Positioning pin
56 Opening
58 Retaining opening
60 Retaining element
62 Retaining pin
64 Openings
70 Tool part
72 Guide element
74a Welding element
74b Welding element
x Longitudinal direction
y Transverse direction
z Vertical direction

1-14. (canceled)

15. A method for producing a lining material for a lining for a vehicle seat, comprising:
a) providing at least one flat starting material,
b) introducing positioning openings into the starting material,
c) inserting at least one layer of the at least one starting material into a tool frame having a plurality of positioning pins, wherein the positioning pins of the tool frame are guided through the positioning openings in the starting material,
d) implementing a material machining process on the at least one inserted layer,
e) removing the at least one machined layer from the tool frame.

16. The method as claimed in claim 15, wherein, subsequent to method step e), the following method steps are provided:
f) inserting the at least one machined layer into a further tool frame,
g) implementing a further material machining process on the at least one layer which is inserted into the further tool frame,
h) removing the at least one previously machined layer from the further tool frame.

17. The method as claimed in claim 15, wherein, between the method steps d) and e), implementation of a further material machining process is carried out on the at least one layer which is inserted into the tool frame or into the further tool frame.

18. The method as claimed in claim 16, wherein, between the method steps g) and h), implementation of a further material machining process is carried out on the at least one layer which is inserted into the tool frame or into the further tool frame.

19. The method as claimed in claim 15, wherein the implementation of the material machining process is limited to predefined regions of the at least one layer.

20. The method as claimed in claim 16, wherein, prior to method step f), at least one further layer which is provided with positioning openings and which is made of at least one starting material is inserted into the further tool frame.

21. The method as claimed in claim 16, wherein, subsequent to method step f), at least one further layer which is provided with positioning openings and which is made of at least one starting material is inserted into the further tool frame.

22. The method as claimed in claim 15, wherein at least two layers made of at least one starting material are inserted in method step c).

23. The method as claimed in claim 15, wherein at least two layers made of at least two different starting materials are inserted in method step c).

24. The method as claimed in claim 20, wherein the at least two layers are oriented relative to one another and relative to the tool frame via positioning pins and the positioning openings.

25. The method as claimed in claim 15, wherein the starting material is formed from at least one of the following materials: a nonwoven, a knitted fabric, a woven fabric, a leather, a synthetic leather.

26. The method as claimed in claim 15, wherein the material machining process comprises at least one of the following measures: sewing, thermal welding, ultrasonic welding, punching, embossing, pressing, grinding, brushing, impregnating, perforating, shagreening, cutting, carving, printing.

27. A lining material for a lining for a vehicle seat, produced by a method as claimed in claim 15.

28. A vehicle seat having a lining comprising a lining material as claimed in claim 27.
